(19) United States
(12) Patent Application Publication
(10) Pub. No.: US 2003/0088941 A1
(43) Pub. Date: May 15, 2003

(54) Clip lock folding operator handle

(76) Inventor: Anthony J. Rotondi, Owatonna, MN (US)

Correspondence Address: Mark D. Lorusso, Lorusso & Loud, 440 Commercial Street, Boston, MA, 02109, US

(21) Appl. No.: 10/294,077

(22) Filed: Nov. 13, 2002

Related U.S. Application Data
(60) Provisional application No. 60/350,760, filed on Nov. 13, 2001.

(51) Int. Cl. E05B 1/00

(52) U.S. Cl. 16/110.1

(57) ABSTRACT

A handle that is extendable and retractable to minimize interference with window decorations and having a feature, which allows removal and attachment of the handle from the crank of the window operator without the use of tools. The handle is removable from the window operator though the use of either a clip lock feature or a spring lock clip both of which can be top down assembled with the minimum of effort and complexity.

### FIELD OF THE INVENTION

The field of the invention is operator handle mechanisms, and more specifically folding and removable operating handles.

### BACKGROUND OF THE INVENTION

Manually operated windows, such as manually operated casement windows require the use of a mechanism called a window operator, that effects movement of the window sash relative to the window frame, for opening and closing of the window. There exists at present many types of mechanisms for opening windows. One such mechanism consists of a window operator driven by a handle (or crank) mounted to the windowpane. Such handle, however, while being essential to the operation of the opening function is a problem.

Window operators of this type typically have a handle or crank that engages with a rotate-able drive shaft that engages a linkage causing movement of the window sash. In operation, the user rotates the handle, which in turn rotates the drive shaft causing movement of the linkage attached to open and close the window.

It is desirable for the user to have easy access to the window's operator handle. To have easy access to the window's operator handle, the tip of the handle that is held by the user will typically extend the maximum possible distance outward from the window frame and not obstruct the motion of the user's hand.

When the window is not being operated, regardless of the position of the window, and when it is desirable to close the window's decoration such as blinds and/or curtains the user would desire to move the handle position without moving the window position. Therefore it is necessary to have the window's operator “handle” stowed out of the way, such that it does not substantially extend outward from the window frame as to obstruct the window's decor. Indeed, any type of interior decoration for a window is faced with the problem of the presence of such handles due principally to the space that it occupies on the interior side of the window. Curtains and/or blinds will be caught in the handles, which is a hindrance continuously met by users, decoration professionals, and designers of windows or window hardware.

Operator's “handles” of the past; have been developed that can be “folded is down” from an operable position for rotation to be stored into a position adjacent to the operator cover, as well as, having a strong enough holding “detent” to aid the retention of the handle in either the opened and/or closed position, so when the users folds and places the handle as desired the position the handle will stay and not adversely move. A “set screw” has been the norm for securing the “handle” to the drive shaft of the operator.

However, known handles that are capable of adequately clearance and retention (folded down & detents) are then typically secured to the drive shaft with non-forgiving and costly to manufacture “set screw” arrangement. All know handles of this type need to have a requirement (set screws or other) so that the handle can be removed and re-positioned several times as to set the handle at a resting and final desired (adjacent or clearance) position.

More so, during new installation or during the ageing life of the window and it's components, such as seals, linkages, etc. change dimension and clearances so that the operator's handles will not end up at the same ending rotation as desired, and thus the “adequate adjacent handle clearance” will be lost until the “handle” is removed from the drive shaft and repositioned.

Other problems faced are that the user highly desires the handle to fold and to have adequate detent and/or retention resistance as to stay in the proper desired position, either during operation or at rest throughout the life of the product. While most known handles have “set screws” to secure and maintain the proper relationship to the drive shaft, other known handles are so designed as to have an “snap off” feature in place of the “set screw”. However, known handles that can “snap off” for re-positioning due to cost and design constrains forgo the “fold down” feature. Furthermore, while the ease of removal is met with the “snap off” type “handles”, they are deficient because they lack the secured clamping force given by a “set screw” type “handles”.

These types of handles having further problem like, while in an effort to ‘clear’ decoration, and having adequate detent as to not move when the window is at the closed position, there is need to remove and reposition the handle several times, both during the first installation, and then during the life of the product. More so, it is this re-movable feature that indeed is highly desirable so that the handle can be positioned at the most effective angle relative to the window decor. And finally the age old problem of cost verse all these features.

Accordingly, there is a need and desire for a window's operator “handle” to not only be capable of “fold down” for clearance, and have the capacity of a secured “detent” to prevent unintentional collapse during rotation, there is a need and desire for a “fold down-detent” handle as a window operator to be so configured to provide secured clamping to the drive shaft of the window's operator and improve on the costly and non-forgiving method, employed either by a “snap on” or “set screw”.

Further, there is a need and desire for a “fold down-detent” handle as a window operator that can be so configured to provide an “easy off” feature to omit the “set screw” and thus omit the costly manufacturing of, or the tool needed to manipulate, the “set screw”, and still maintain a variety of aesthetically pleasing handle appearances and shapes.

Furthermore, there is a need and desire for a “fold down-detent-easy off” handle, as a window operator that is compact, stylist and manufacture-able at a relatively low cost, while providing for substantial wear resistance and reliable use.

### SUMMARY OF THE INVENTION

The present invention relates to a casement window operator. The “handle” of this window operator is securable to a window operators drive shaft. The handle is collapsible from an operable position to a storage position.

The components that make up the window operator's handle includes a “base”, a “handle (with knob)” a “base retainer clip” and “drive shaft clip” so configured as to engage the window operator's drive shaft to meet the desired features of a “low cost-fold down-detent-easy off-handle”.

The present invention is so configured as to be two different embodiments, both with the feature of a “low cost-fold down-detent-easy off” handle. The first embodiment is an ingenious design which results in low cost by design in manufacturing and assembly wherein said embodiment, “folds down”, having both a open and closed “detent”, and so configured to have a button shape built into the “drive shaft clip”, where the user must push the button to release the retention of the “handle” relative to the operator's drive shaft, so now, the “handle” can be hand removed and repositioned. This embodiment will be referred to as a “low cost-fold down-detent-clip off” folding “handle”.

The second embodiment is also; low cost by design, “folds down”, having both a open and closed “detent”, and so configured to have a “snap off feature, where the user has to hand pull against the resistance of the snap to release the retention to the drive shaft, the “handle” can now be hand removed and repositioned, and will be referred to as a “low cost-fold down-detent-snap off” folding “handle”.

Both embodiments are so configured to have the same “handle” and “base retainer”, where the “base” differs slightly in design, as to be fitted with two different “drive shaft clips”, one for “clip on” and one for “snap on”.

Further, in both embodiments the “drive shaft clip” is inserted into their respective “base”, whereby the “base” is held down and in place into the “handle” by the “base retainer clip”.

Furthermore, in both embodiments when the “handle” is in the operating position the “drive shaft clip” is always firmly pressing against the drive shaft of the window's operation, keeping the “handle” firmly in place.

These embodiments as with other known “folding handles”, will incorporate at one end a “pin” and “knob” sub-assembly, allowing the handle to have a swivel knob feature, but the other end differs in both design and function to other known “folding handles”, where the “side pin”, and/or “metal spring”, and a “metal set screw” or “metal snap clip” as been removed.

The advantages over other known “folding handle” lie in the sub and component assembly, like the omission of the “side pin”, “spring” and “set screw”. The complexity and time consumption in staking assemblies that “side” install and install “under preload” due to the components generally requires special equipment, adding complexity to the overall installation and increasing final assembly cost because of this complexity.

The method of “drop down” and assembling “under no pre-load” of components into the “handle”, improves the overall ease of manufacturing the product along with cost reduction associated.

More so, the present invention using a configuration of internal components that make up “the handle assemble” are the, “base”, “a handle, optionally with a knob”, “a base retainer clip”, and “a drive shaft clip”, as to engage the window operator's drive shaft to meet the desired features of a “low cost-fold down-detent-easy off-handle”.

The “handle” is so configured as to accommodate the “base”, the “handle's knob”, the “base retainer clip”, and the “drive shaft clip”. The “handle” may be cast with several features like a pair of slots for the “base” to rest and a configured area for retaining the “base retainer clip”, allowing the “base” to pivot without the need of a “side pin”, thus eliminating the costly assembly inherent in known designs.

Furthermore, the “handle” may be so configured and cast to have adequate enough space for “top down” assembly, allowing the “base” and “base and retainer clip” to be staked without the need of a pre-load on the assembly. The invention's optional “handle” construction and casting, omits the need for a precise side cored hole or required machining of a precise side hole, furthermore the “handle” may be cast in a simple “top down” direction, as to be the fastest, least expensive possible method of manufacturing. The “base” may also be configured as to have two external inline diameter bosses, where these bosses are the ‘pivoting pin’ for the “base” and are located and retained by the “base retainer clip” at the bottom of a pair of slots in the “handle”.

Additionally, the “base” may be optionally configured to integrally form a pair of ‘wings’ that engage with the “base retainer clip”, preferably at two locations, for the purpose of enacting resistance by ‘detent’ force, when the “handle” is folded down or up position. The optional ‘wings’ deflect and snap onto a landing formed into the “base retainer clip” and act as a positive tactile indication that the handle is in the respective position.

The “base” may also be so configured as a simple cast part having a pair of slots capable of retaining and allowing the “drive shaft clip” to fit and function as the retainer to the drive shaft of an window operator. More so, the main feature of the “base” may be configured and cast as to be the driving receptacle for the window operators drive shaft.

This invention provides an advantage over known “internal components” in that it is made by the “base” being of a simple cast configuration and handling three functions in one, that being the “pivot point—drive locking receptacle and detent spring” while maintaining a “top down” assembly feature, as to be the fastest, least expensive possible method of manufacturing. The “base retainer clip” may be configured to be a simple formed metal part, to serve the function of retaining the “base” in the “handle”, while interacting with the “base's” wings to form two detents when the “handle” is folded up or down position.

Furthermore the “base retainer clip” may be configured as to hook onto the is “base's” inline ‘diameter bosses’ and snap over the ‘wings’ as a pre-assembly, allowing these two components to be installed into the “handle” top down and without pre-load.

This invention is superior over other known typical “internal components” would be the difference of “formed spring steel” verse standard “steel” to make a retainer clip, and as so configured while maintaining a “top down” assembly feature, and therefore the fastest method of manufacturing.

The “drive shaft clip” that replaces “set screw” designs, is so configured as to replace the costly “set screw” style of retaining handle on the operators drive shaft. The “drive shaft clip”, which may be configured and simply cast to have a button shape on one end, and a two ‘fork’ arrangement protruding opposite the button.

Furthermore, the “drive shaft clip”, may be configured so that the forks' extends through, and are contained by the “base” and will come in contact with the “handle” when the handle is lifted into use. This lifting action pushes the ‘forks’ so that an area on the ‘forks’ locks and wedges against the operator's drive shaft. More so, when the user desires to release the “handle assembly” for the operator's drive shaft, no tools are needed, the users simply tilts the “handle” allowing clearance for the “drive shaft clip's” ‘forks’ to be ‘moved to’, and the user needs only to push the button end of the “drive shaft clip” so that the wedge retained by the ‘forks’ against the operator's drive shaft will be released.

Therefore the “drive shaft clip” that replaces the known “set screw” design, has several advantages over a “set screw”, foremost by not requiring that a costly threaded hole be place into the “base” and that a “set screw” if not tighten currently damage will result to the operator's drive shaft. Furthermore, with this invention's configuration each time the handle is lifted into use, the ‘wedge effect’ results, locking and securing the “handle assembly” against the operator's drive shaft. More so, at the desire of the user the “handle assembly” can be quickly and easily removed without damage to the operator's drive shaft and without the need of extra tools.

In one embodiment the “drive shaft clip” that replaces “snap off” designs, is so configured as to replace the costly ‘spring steel’ clip that requires a secondary staking operation in the known “base” that houses the assembly. Further, the “drive shaft clip”, is so configured and simply cast to have two ‘forks’ protruding from one end and a solid surface opposite the forks.

Furthermore, the “drive shaft clip”, is so configured so that the ‘forks’ extends through, and are contained by the “base” while the solid surface end comes in contact with the “handle”, insomuch that when the handle is lifted into use the ‘forks’ locks and wedges against the operator's drive shaft. More so, when the user desires to release the “handle assembly” for the operator's drive shaft, no tools are needed, the users simply tilts the “handle” allowing clearance for the “drive shaft clip's” ‘forks’ to be non-containing about the drive shaft, user needs only to lift the handle off the operator's drive shaft with a low force detent effect.

The “drive shaft clip” that replaces the known “snap off” designs has several advantages over a steel “snap off” clip, foremost by not requiring that a costly “spring steel” component be staked into the “base”. Further, that a steel “snap off” clip is never securely tightened to the operator's drive shaft, insomuch that the is “handle assembly” can pop off unintentionally by the user. This invention is configured, so that each time the handle is lifted into use, the ‘wedge effect’ and not the “snap off” feature is the result, locking and securing the “handle assemble” against the operator's drive shaft during use. More so, at the desire of the user the “handle assembly” can be quickly and easily removed without damage to the operator's drive shaft and without the need of extra tools.

### BRIEF DESCRIPTION OF THE DRAWING

FIG. 1 is a perspective view of the snap-on drive shaft clip.

FIG. 2 is an end view of the snap-on drive shaft clip.

FIG. 3 is a top view of the snap-on drive shaft clip.

FIG. 4 is a side view of the snap-on drive shaft clip.

FIG. 5 is a top view of the handle clip.

FIG. 6 is a side view of the handle clip.

FIG. 7 is a perspective view of the handle clip.

FIG. 8 is an end view of the handle clip.

FIG. 9 is a cut away view of the handle.

FIG. 10 is a side view of the handle.

FIG. 11 is a top view of the handle.

FIG. 12 is a perspective view of the handle.

FIG. 13 is an internal view of the handle.

FIG. 14 is a side view of the snap base.

FIG. 15 is a bottom view of the snap base.

FIG. 16 is a front view of the snap base.

FIG. 17 is a perspective view of the snap base.

FIG. 18 is a top view of the worm clip.

FIG. 19 is a side view of the worm clip.

FIG. 20 is a perspective view of the worm clip.

FIG. 21 is an end view of the worm clip.

FIG. 22 is a side view of the clip base.

FIG. 23 is a bottom view of the clip base.

FIG. 24 is a front view of the clip base.

FIG. 25 is a perspective view of the clip base.

### DETAILED DESCRIPTION OF THE PREFERRED EMBODIMENT

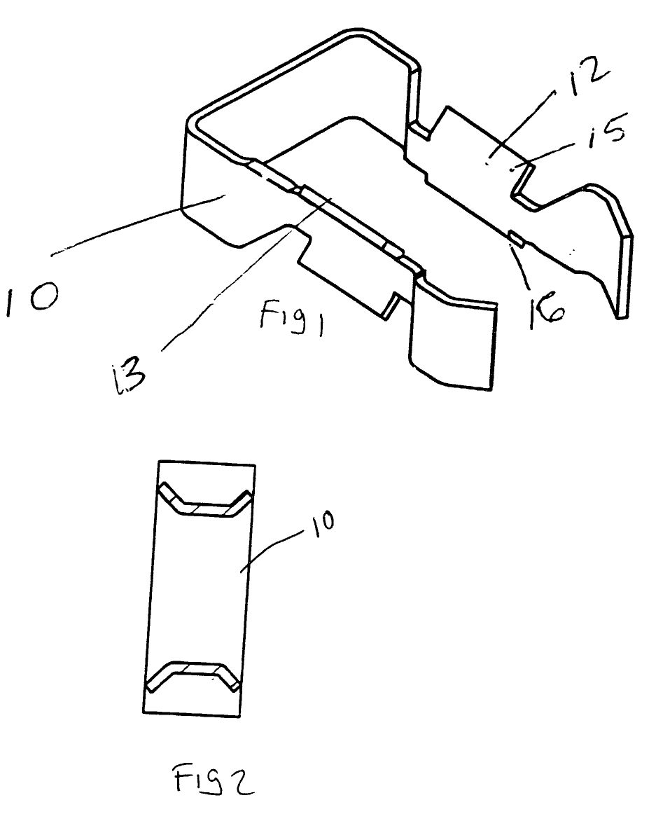

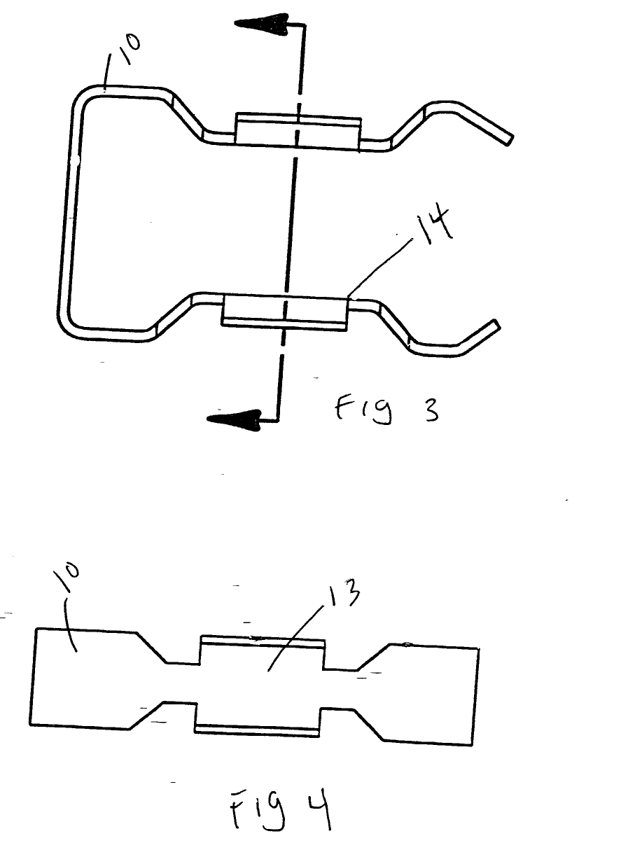

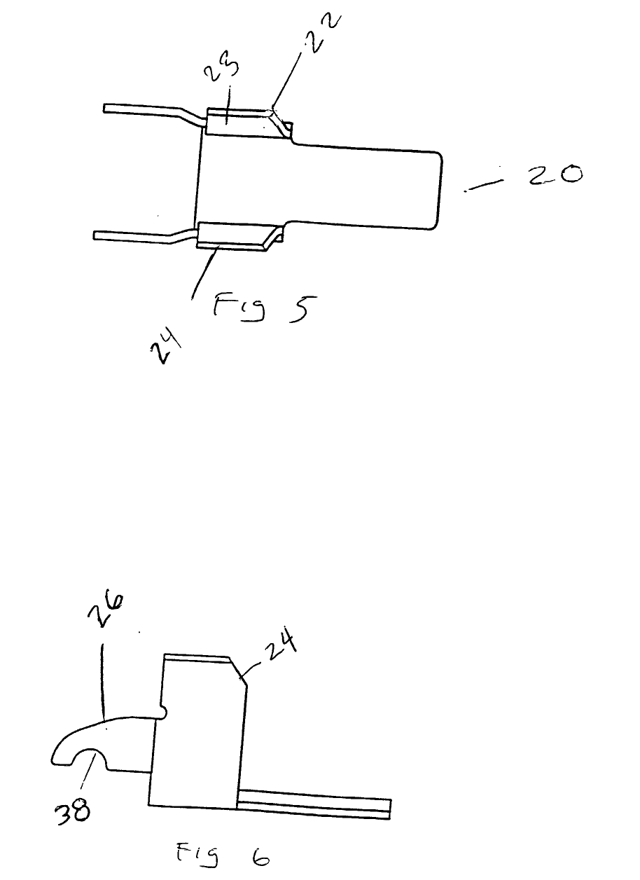

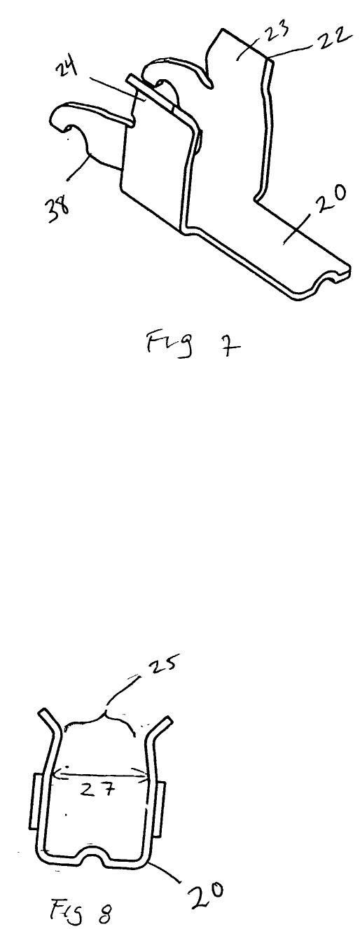

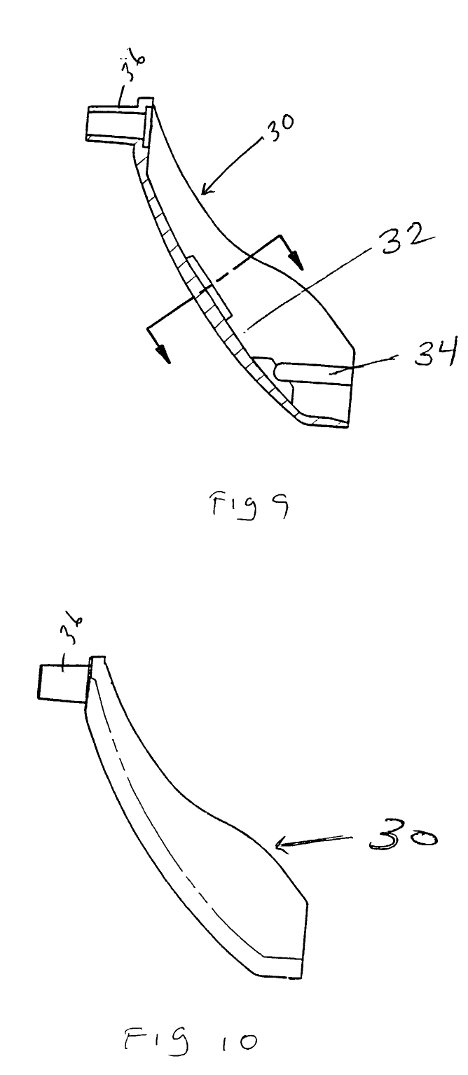

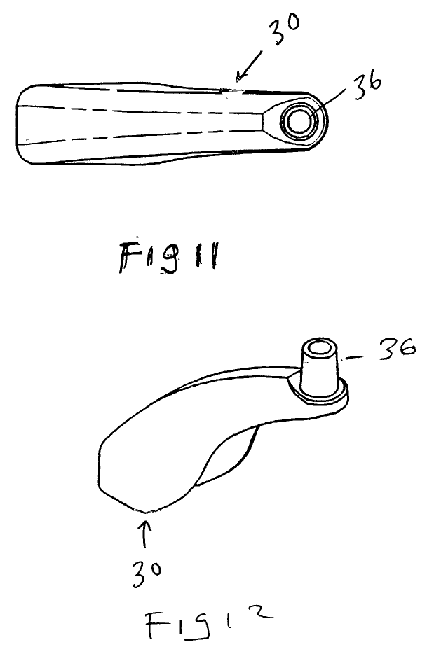

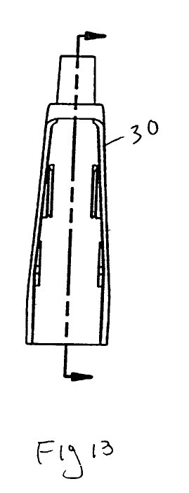

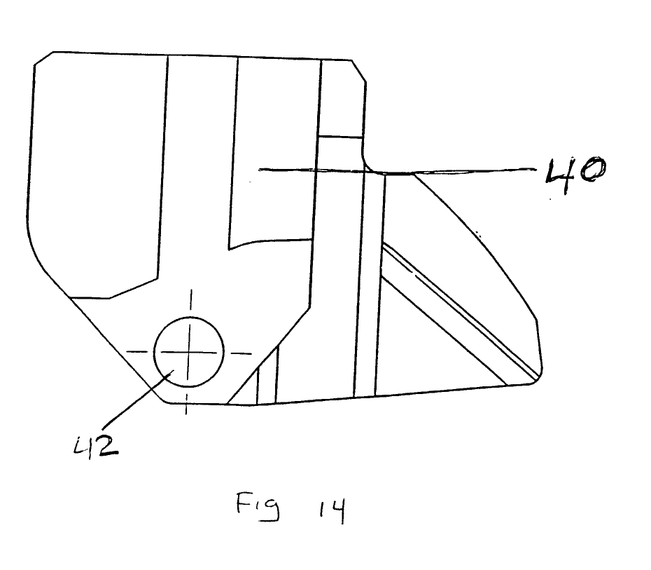

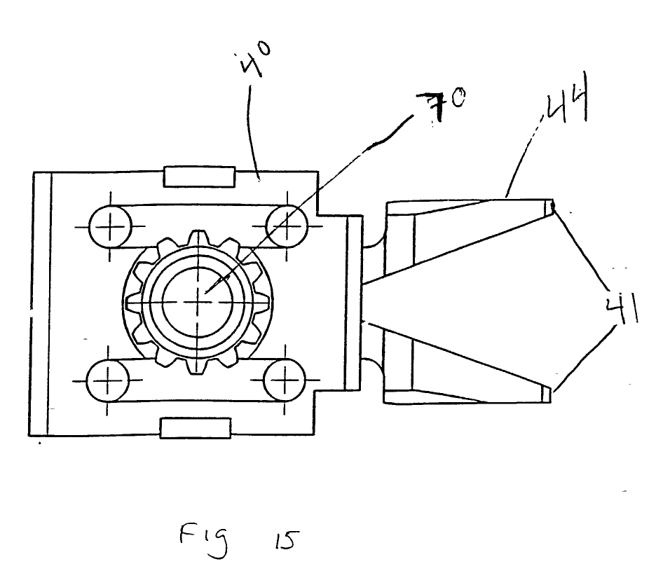

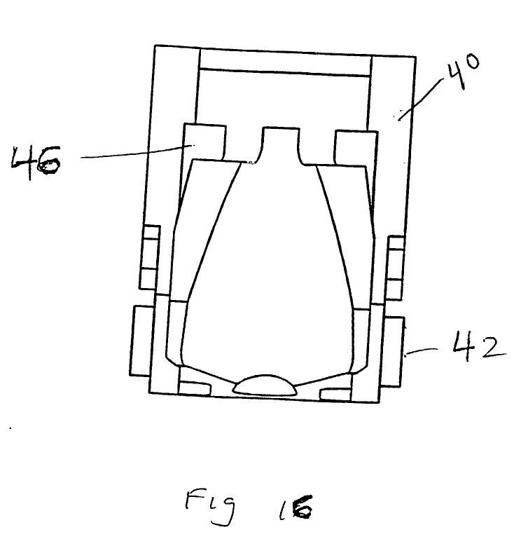

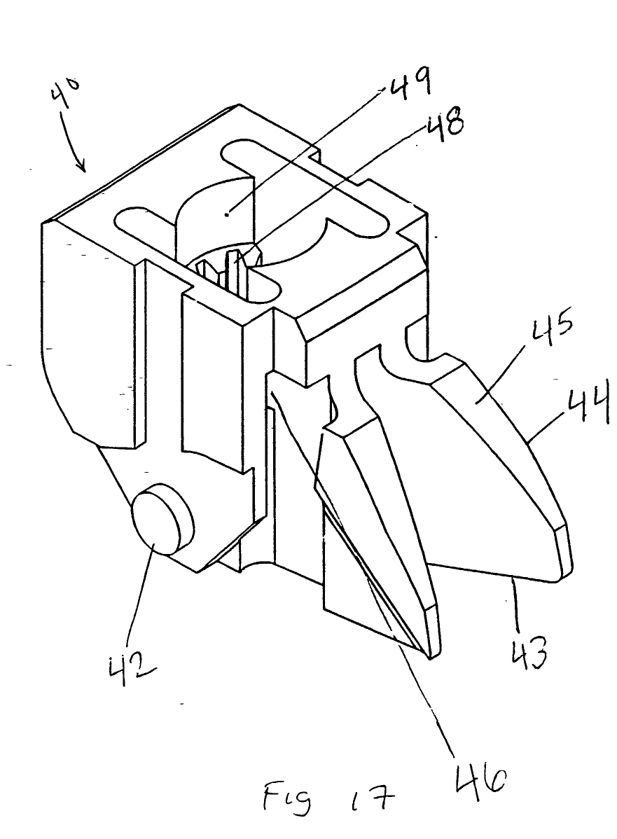

In one embodiment as displayed in FIGS. 1-17, a handle 30 wherein a handle clip 20 interacts with a snap base 40. Handle clip 20 rotatably affixes said snap-base 40 to the underside 32 of said handle. A snap-on shaft clip 10 is positioned within snap base 40.

FIGS. 1-4 displays a snap-on shaft clip 10 positioned within a snap base 40 as displayed in FIGS. 14-17, wherein said snap-on shaft clip 10 allows a handle 30 as displayed in FIGS. 9-13, to be moveable between a position in which said snap base 40 is capable of engaging a window crank 70 to engage said linkage to cause movement of said sash, and through an application of a line of force substantially perpendicular to a rotation of said rotatable drive shaft, to a second position which is capable of allowing release of said handle 30 and a subsequent reattachment of said handle 30 in preferred positions upon said rotatable drive shaft 70 of said window operator without using any tools.

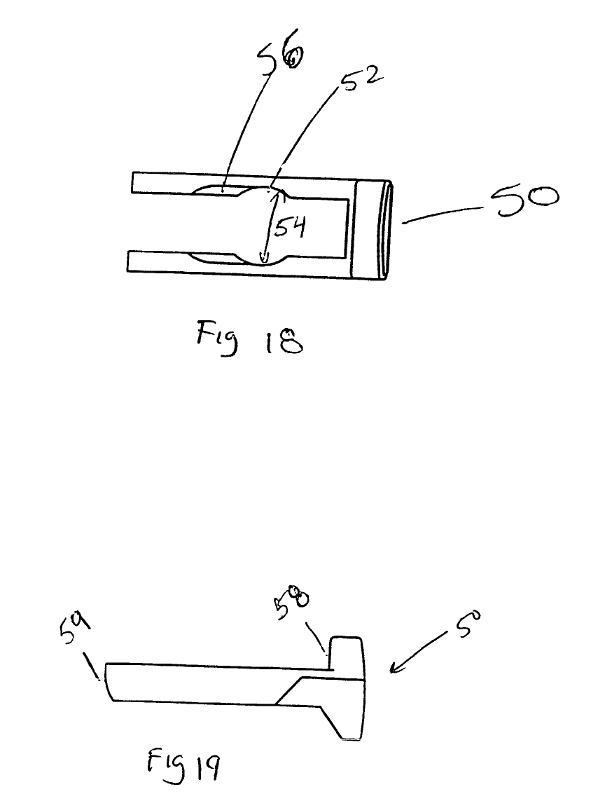

FIGS. 1-4 displays the snap-on shaft clip 10, which is shaped to fit into a snap base receiving slot 46 as displayed in FIGS. 16-17, which positions the snap-on shaft clip 10 to interact with window crank 70 as displayed in FIG. 15. The resiliently biased snap-on wing 12 allows window crank 70 having a splined end 72 to pass through opening 14 having a diameter less than splined end 72, which is positioned between at least one snap-on wing 12 and a second snap-on wing 13, or one snap-on wing 12 and the snap base spline 48 or snap base entrance lip 49.

FIGS. 1-4 and 14-17 displays that the snap-on wing 12 has exit incline 15 and entrance incline 16 which transitions the wing diameter between an opening 14 greater than snap base spline 48 diameter till it reaches snap-on wing 12 opening diameter which is less than the snap base spline 48 providing a ramping of force for smooth transition between handle attached and unattached conditions. Handle 30 interacts with snap base spline 48 through its rotatable connection to underside 32 via handle clip 20. When handle 30 is in an unattached condition the user may position handle in desired location in relation to the position of the windowpane. Once properly positioned user directs a force through handle 30 along a line substantially perpendicular to the rotation of window crank 70.

When the user applies force (pushing the base of handle towards the window operator) to the properly positioned handle 30 the splined end 72 of window crank 70 comes in contact with at least one entrance incline 16. As force is applied to handle 30 it causes splined end 72 to deflect snap-on wing 12, continued application of force causes snap-on wing 12 to pass splined end 72 and pass into a narrow crank region 74. The narrow crank region 74 allows resiliently biased exit incline 16 section to resume to a less deflected position. This resiliently biased deflection of snap-on wing 12 causes a positive feel to user to ensure that the handle is fully secured upon splined end 72 to allow the user to operate the window assembly.

When the user desires to remove the handle 30 for ideal repositioning the above process is repeated in reverse order. The user grasps the handle 30 and pulls away from the operator in a line of force perpendicular to the rotation of the window crank 70. As a pulling force is applied to handle 30 it causes splined end 72 to again deflect exit incline 16 and then snap-on wing 12, continued application of force causes snap-on wing 12 to exit narrow crank region 74 passing splined end 72 and then into contact with resiliently biased exit incline 16 allowing section to resume to a less deflected position as it assists exit of the splined end 72 from contact with snap base spline 48. Handle 30 is now in a condition to allow repositioning and reattachment if desired.

When handle 30 is attached to the splined end 72 of the window crank 70 it can be moved between an extended position which allows for easy cranking and a storage position to minimize interference with window decorations. FIGS. 5-17 displays handle clip 20 attached to the underside 32 of handle 30. Handle clip 20 has at least one resiliently biased handle wing 22 and optionally handle wing 24 in addition, which is outwardly deformable but returns to original shape even after repeated use. The handle wing 22 deforms when it intimately contacts resiliently biased snap base fork 44 included on snap base 40.

The snap base fork 44 is positioned to interact with handle wing 22, which is ensured through the use of snap base protrusion 42, which is rotatably positioned by mechanical blocking through the use of at least one retaining handle wing 26, which has a rotation axis guide 28. Snap base protrusion 42 is thus held in place through blocking of rotation axis guide 28 within the underside 32. Optionally a groove 34 is formed in the underside 32 of handle 30, which provides additional rotational guidance for snap base 40 by additionally mechanically blocking snap base protrusion 42 within groove 34.

When handle 30 is in the extended position, which allows for easiest window operator option wherein at least one handle wing 22 rests against snap base fork face 43. The contact between the two surfaces allows for a positive feel without fear of collapse when the user rotates handle 30 to actuate the window operator. User must provide a greater force to collapse handle 30 to its retracted position then the resistance provided by the incline wing face 23 of handle wing 22 against the snap base fork 44.

When the user wishes to retract the handle to the collapsed position to allow for the placement of window decorations without interference from the handle he provides force preferably at the knob 36 pushing toward the window operator. When the user provides a sufficient amount of force snap base 40 remains in a fixed position because of its attachment to the window operator while handle clip 20 rotationally moves inward to encompass and surround snap base 40 thereby causing the knob 36 of handle 30 to lie flush with the base of the window operator. This is accomplished through the biased resilience of handle wing 22 and snap base fork 44 interacting with each other, however only one of the two acting in cooperation needs to be resiliently biased to allow for the retraction and extension of the handle.

The retraction of the handle 30 so that knob 36 is flush with the operator base occurs when a force causes handle wing 22 to override the positionally fixed snap base 40. Snap base fork face 43 physically contacts the inclined face of handle wing 22, which causes the reliantly biased material of at least one snap base fork 44 to compress inwards causing the overall snap base wing diameter 41 to be reduced to a point in which passage of the at least one of the snap base fork 44 passes through the handle clip opening 25. Interior opening 27 of handle clip 20 is wider than handle clip opening 25 wherein this causes the user to feel a physical and positive feedback that the handle 30 is fully in the retracted position. Additionally this allows the either or both of the resiliently biased members to return to a more normal position allowing for extended life of the components by reducing stress on flexing components and maintaining elasticity for the longest possible time for all associated components.

When the user wishes to extend the knob 36 of handle 30 from the retracted position to the extended position to facilitate easier window operation it occurs by pulling the knob 36 away from the window operator base until the knob 36 locks into the extended position. This pulling motion on knob 36 causes at least one snap base fork 44 to compress and pass through handle clip opening 25. After at least one snap base fork 44 passes through handle clip opening 25 it then resumes to its uncompressed dimensions. The force required to recompress either the snap base fork 44 and/or the handle wing 22 is what provides the positive feel that occurs during the transition and the stability of the handle 30 in the extended position.

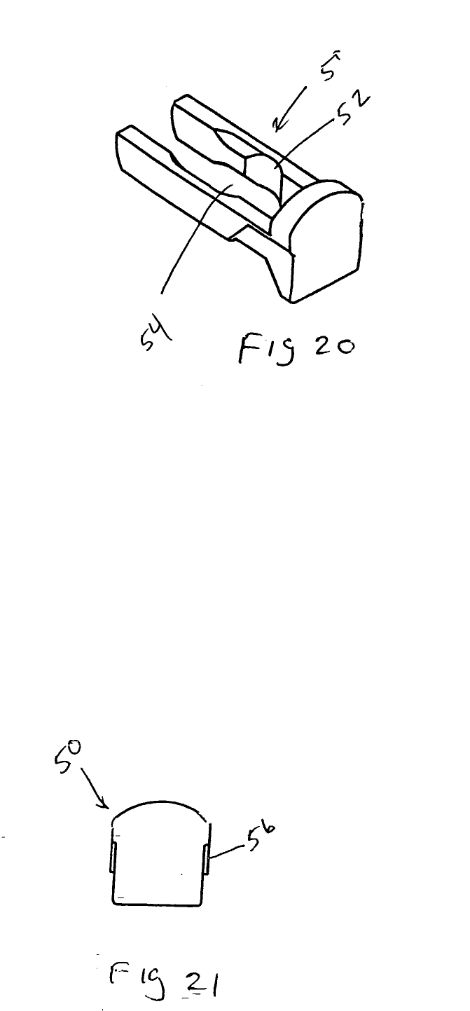

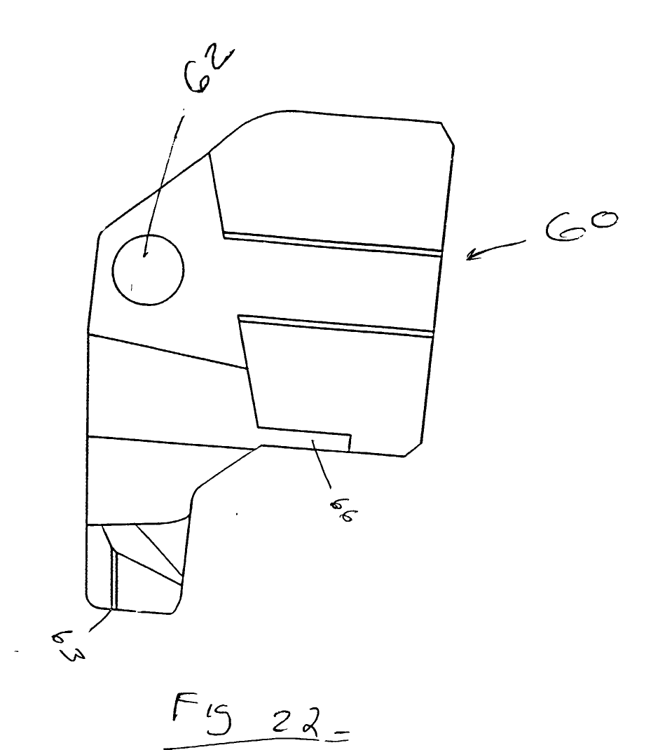

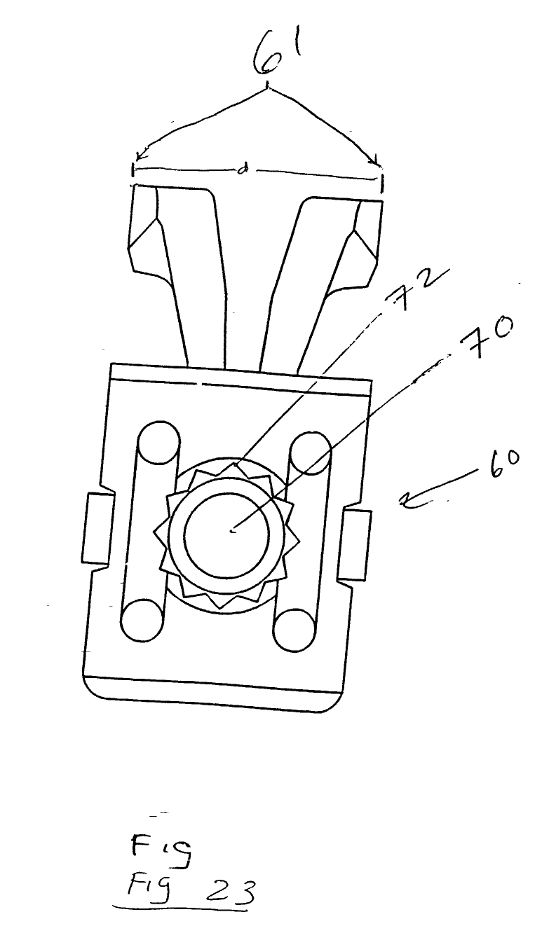

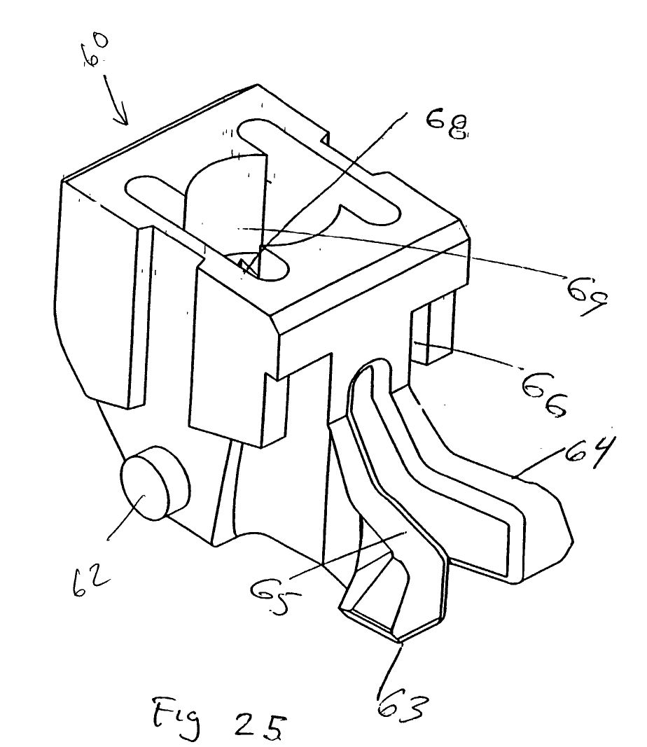

Another embodiment is displayed in FIGS. 5-8, 9-12, and 18-25, wherein a window operator having a window crank 70 is rotated by a handle 30, wherein a handle clip 20 interacts with a worm clip 50 to transmit rotational force. Handle clip 20 rotatably affixes said clip base 60 to the underside 32 of said handle. A worm clip 50 is positioned within clip base 60.

FIGS. 18-21 displays a worm clip 50 positioned within a clip base 60 as displayed in FIGS. 22-25, wherein said worm clip 50 allows a handle 30 as displayed in FIGS. 9-13, to be moveable between a position in which said clip base 60 is capable of engaging a window crank 70 to engage said linkage to cause movement of said sash, to a second position which is capable of allowing release of said handle 30 and a subsequent reattachment of said handle 30 in preferred positions upon said rotatable drive shaft 70 of said window operator without using any tools.

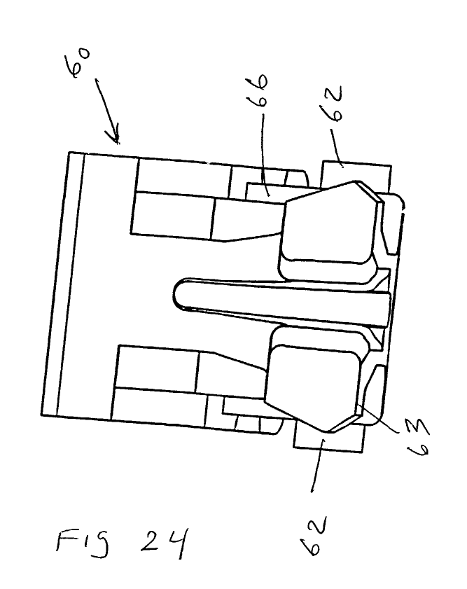

FIGS. 18-21 displays the worm clip 50, which is shaped to fit into a worm clip receiving slot 66 as displayed in FIGS. 22-25, which positions the worm clip 50 to interact with window crank 70 as displayed in FIG. 23. The spline groove 52 allows window crank 70 having a splined end 72 to pass through clip opening 54 having a diameter greater than splined end 72, which is positioned within worm clip receiving slot 66 to allow splined end 72 to pass through clip opening 54.

Handle 30 interacts with clip base spline 68 through its rotatable connection to underside 32 via handle clip 20. When handle 30 is in an unattached condition the user may position handle in desired location in relation to the position of the windowpane. Once properly positioned user directs a force through handle 30 along a line substantially perpendicular to the rotation of window crank 70.

When the user applies force to button 52 it causes splined end 72 to be contacted by clip lock 56 in a narrow crank region 74. The narrow crank region 74 allows the handle 30 to be fully secured upon splined end 72 to allow the user to operate the window assembly. Clip lock 56 allows rotation of window crank 70 by the user via rotation of the handle 30 while simultaneously blocking splined end 72 from unintentionally passing back through clip lock 56 during operation of window assembly. Further safeguards to prevent unintentional release of the handle 30 during rotation is by optionally mechanical blocking the movement of worm clip 50 to the handle release position when the handle is in the extended position by the use of clip release block 59.,

When the user desires to remove the handle 30 for ideal repositioning the above process is repeated in reverse order. When the optional safeguard mechanism is included the handle must be in the retracted position to remove it from the window crank 70. The user repositions button 52 to allow for release of window crank 70. Optionally positive stop surface 58 can be included on worm clip 50 to inform user that the handle 30 is in a condition to allow for its release. The opening 54,is positioned in line with splined end 72 and clip base opening 69. When handle 30 is then pulled away from window operator it allows splined end 72 to pass through both opening 54 and clip base opening 69, releasing splined end 72 from contact with clip base spline 68. Handle 30 is now in a condition to allow repositioning and reattachment if desired.

When handle 30 is attached to the splined end 72 of the window crank 70 it can be moved between an extended position which allows for easy cranking and a storage position to minimize interference with window decorations. FIGS. 5-17 displays handle clip 20 attached to the underside 32 of handle 30. Handle clip 20 has at least one resiliently biased handle wing 22 and optionally handle wing 24 in addition, which is outwardly deformable but returns to original shape even after repeated use. The handle wing 22 deforms when it intimately contacts resiliently biased clip base fork 64 included on clip base 60.

The clip base fork 64 is positioned to interact with handle wing 22, which is ensured through the use of worm protrusion 62, which is rotatably positioned by mechanical blocking through the use of at least one retaining handle wing 26, which has a rotation axis guide 28. Optionally a groove 34 is formed in the underside 32 of handle 30, which provides additional rotational guidance for clip base 60.

When handle 30 is in the extended position, which allows for easiest window operator option wherein at least one handle wing 22 rests against clip base surface 63. The contact between the two surfaces allows for a positive feel without fear of collapse when the user rotates handle 30 to actuate the window operator. User must provide a greater force to collapse handle 30 to its retracted position then the resistance provided by the handle wing 22 and the clip base fork 64.

When the user wishes to retract the handle to the collapsed position to allow for the placement of window decorations without interference from the handle he provides force preferably at the knob 36 pushing toward the window operator. When the user provides a sufficient amount of force clip base 60 remains in a fixed position because of its attachment to the window operator while handle clip 20 rotationally moves inward to encompass and surround clip base 60 thereby causing the knob 36 of handle 30 to lie flush with the base of the window operator. This is accomplished through the biased resilience of handle wing 22 and clip base fork 64 interacting with each other, however only one of the two acting in cooperation needs to be resiliently biased to allow for the retraction and extension of the handle.

The retraction of the handle 30 so that knob 36 is flush with the operator base occurs when a force causes handle wing 22 to override the positionally fixed clip base 60. Clip base surface 63 physically contacts the inclined face of handle wing 22, which causes the reliantly biased material of at least one clip base fork 64 to compress inwards causing the overall clip base fork diameter 61 to be reduced to a point in which passage of the at least one of the clip base fork 64 passes through the handle clip opening 25. Interior opening 27 of handle clip 20 is wider than handle clip opening 25 wherein this causes the user to feel a physical and positive feedback that the handle 30 is fully in the retracted position. Additionally this allows the either or both of the resiliently biased members to return to a more normal position allowing for extended life of the components by reducing stress on flexing components and maintaining elasticity for the longest possible time for all associated components.

When the user wishes to extend the knob 36 of handle 30 from the retracted position to the extended position to facilitate easier window operation it occurs by pulling the knob 36 away from the window operator base until the knob 36 locks into the extended position. This pulling motion on knob 36 causes at least one clip base fork 64 to compress and pass through handle clip opening 25. After at least one clip base fork 64 passes through handle clip opening 25 it then resumes to its uncompressed dimensions. The force required to recompress either the clip base fork 64 and/or the handle wing 22 is what provides the positive feel that occurs during the transition and the stability of the handle 30 in the extended position.

While every possible theoretical embodiment is not listed above, it is clearly envisioned by the inventor that all theoretical variations based upon an interaction of similarly performing elements is supported. The applicant claims within the scope of equivalents all embodiments having similarly performing features with a similar combination of elements either by the combining of functions into one element or the breakdown of larger elements and being replaced with the addition of multiple elements to perform the same basic functions.

I claim:

1. A snap detachable fold down handle for attachment to a window crank of a window operator comprising:
a handle having an underside;
a handle clip affixed to said underside within said handle;
a snap base having a snap-on shaft clip receptacle formed therein and contoured to fit within said handle clip when said handle is in a retracted position, wherein said snap base is pivotally affixed to said handle clip and is detachably positionable and shaped to encompass the window crank of the widow operator; and,
a snap-on shaft clip positioned within said snap base wherein said snap-on shaft clip allows said handle to be moveable between a position in which said snap base is capable of engaging the window crank to cause movement of said sash, and through an application of a line of force substantially perpendicular to a rotation of the window crank, and to a second position which is capable of allowing release of said handle and a subsequent reattachment of said handle in a preferred position upon the window crank of the window operator without using any tools.

2. The handle according to claim 1 wherein said snap base has an interior portion which has a contour shape to intimately contact the window crank to permit transmission of rotation force from said snap base to the window crank, wherein said interior portion intersects said snap-on shaft receptacle.

3. The handle according to claim 2 wherein said snap-on shaft clip has at least one snap-on wing that is resiliently biased to allow the window crank to pass through an opening in said snap-on shaft clip allowing the window crank into intimate contact with said interior portion of said snap base and permit operation of the window operator via the window crank through rotation of said handle and preventing unintentional release of said handle from the window crank.

4. The handle according to claim 3 wherein said snap-on shaft clip further comprises:
at least one entrance incline which is resiliently biased;
at least one exit incline which is resiliently biased wherein said inclines facilitate passage of the window crank through said opening of said snap-on shaft clip providing positive feedback.

5. The handle of claim 1 wherein said underside of said handle has at least one groove.

6. The handle of claim 5 wherein said handle clip has at least one pivot guide arm, wherein said guide arm works in cooperation with said groove in said handle to prevent movement of said snap base while allowing pivot action.

7. The handle of claim 6 wherein said snap base has at least one snap protrusion designed to rotate and being mechanically captured by said groove in said handle.

8. The handle of claim 7 wherein said handle clip has a rotation axis guide on said pivot guide arm which works in concert with said grove in said handle to lock said snap base in position while rotating about said snap protrusion.

9. The handle of claim 1 wherein said handle clip has at least one handle wing.

10. The handle of claim 9 wherein said handle wing of said handle clip interacts with said snap base, wherein when passing said handle from a handle retracted position to a handle extended position, said handle wing positions said handle completely into either said retracted position or said extended position.

11. The handle of claim 10 wherein said handle wing has a wing face which facilitates movement of said snap base to within said handle clip when said handle is moved to said retracted position.

12. The handle of claim 1 wherein said snap base has at least one snap fork having a resilient point.

13. The handle of claim 12 wherein said snap fork of said snap base interacts with said handle when passing from a handle retracted position to a handle extended position wherein said snap fork positions said handle completely into either said retracted position or said extended position.

14. The handle of claim 1 wherein said snap clip has at least one resilient snap-on wing wherein said snap-on wing creates a distance less than required to receive the window crank.

15. The handle of claim 14 wherein said resilient snap-on wing is a pair of parallel arms is just capable of receiving the window crank through outward deflection of said parallel arms.

16. A clip-lock detachable fold down handle for attachment to a window crank of a window operator comprising:
a handle having an underside, wherein said handle has a retracted position and an extended position;
a handle clip affixed to said underside within said handle;
a clip base having a clip receptacle formed therein, wherein said clip base is pivotally affixed to said handle clip and shaped to fit within said handle clip when said handle is in said retracted position, and wherein said clip base has an opening which intimately contacts the window crank to transmit rotation of said handle to the window operator when said handle is attached to the window crank;
a worm clip slidingly placed into said clip base moveable between a first position which said worm clip is capable of engaging the window crank to prevent release of said handle from the window operator and a second position which is capable of allowing release of said handle from said window operator.

17. The handle of claim 16 further comprising a quick release button on said handle that interacts with said worm clip allowing release of said handle from the window crank.

18. The handle of claim 16 further comprising a button on said worm clip that assists positioning said worm clip from said first position to said second position.

19. The handle of claim 16 wherein said worm clip has a clip release block, which prevents release of said handle from the window crank when said handle is in said extended position.

20. The handle of claim 16 wherein said underside of said handle has at least one groove.

21. The handle of claim 20 wherein said clip base having at least one protrusion interacts with said groove within said handle allowing said clip base to pivot about said protrusion.

22. The handle of claim 20 wherein said handle clip has at least one pivot guide arm, wherein said guide arm works in cooperation with said groove in said handle to prevent movement of said base worm clip while allowing pivot action.

23. The handle of claim 16 wherein said handle clip has a handle wing with at least one flexible point.

24. The handle of claim 17 wherein said handle wing of said handle clip interacts with said clip base, wherein when passing said handle from a handle retracted position to a handle extended position, said handle wing positions said clip base completely into said handle clip.

25. The handle of claim 16 wherein said clip base has at least one clip base fork.

26. The handle of claim 25 wherein said clip base fork of said clip base interacts with said handle clip when passing between a handle retracted position to a handle extended position wherein said clip fork positions said clip base either completely within or completely outside of an opening of said handle clip.

27. The handle of claim 26 wherein said clip fork is a pair of parallel arms wherein said arms are separated a distance greater than the opening of said handle clip.

28. The handle of claim 16 wherein said worm clip has an opening having a diameter greater than that of the window crank, allowing the window crank to pass through said opening of said worm clip and pass into said clip base opening to allow intimate contact with the window crank.

29. The handle of claim 16 wherein said worm clip has a clip lock section that prevents the window crank from being unintentionally released from said clip base while allowing rotation of said handle.

30. The handle of claim 16 wherein said worm clip has a positive stop surface to indicate position of said worm clip within said clip base.

31. A method of assembling a detachable handle comprising the steps of:
providing a window operator having a window crank;
providing a handle with an underside;
providing a base with a clip receptacle and an opening shaped to intimately receive the window crank;
providing a handle clip shaped to encompass said base when said handle is in a retracted position;
providing a clip to secure the window crank within said base;
placing said base within said underside of said handle;
securing said handle clip to said underside of said handle wherein said base is rotatably secured to the underside of said handle;
inserting said clip into said clip receptacle;
placing said opening of said base over the window crank; and, securing said handle to the window crank to allow rotation of said handle.

32. The method of assembling a detachable handle of claim 31 wherein said base is a snap base and said clip is a snap-on shaft clip wherein said handle is secured to the window crank by pushing said handle against the window operator.

33. The method of assembling a detachable handle of claim 31 wherein said base is a clip base and said clip is a worm clip wherein said handle is secured to the window crank by sliding said worm clip to a position within said clip receptacle to mechanically block removal of said handle from the window operator.
